(19) United States
(12) Patent Application Publication
(10) Pub. No.: US 2021/0081963 A1
(43) Pub. Date: Mar. 18, 2021

(54) SYSTEMS AND METHODS FOR USING NETWORK ATTRIBUTES TO IDENTIFY FRAUD

(71) Applicant: JPMORGAN CHASE BANK, N.A., New York, NY (US)

(72) Inventor: Shweta PATEL, Hadapsar (IN)

(21) Appl. No.: 17/019,940

(22) Filed: Sep. 14, 2020

Related U.S. Application Data
(60) Provisional application No. 62/900,057, filed on Sep. 13, 2019.

(51) Int. Cl. G06Q 30/00

(52) U.S. Cl. CPC G06Q 30/0185

(57) ABSTRACT

A method for using network attributes to identify potential fraud may include: receiving input data comprising at least one of new application data, existing relationship data, customer contact data, and event/transaction data from one or more database, each input data tagged with an indication of fraud or no fraud; transforming the input data into link-level paired data; creating a network mathematically represented by a matrix based on the link-level paired data; creating network attributes from the matrix at an element level, an entity level, and a sub-network level; for each node, link, or sub-network in the network, generating a fraud propensity attribute comprising at least one of a distance, a density, a centrality, and a degree or rate of fraud concentration of based on the network attributes and the input data tagging; and outputting fraud propensity attributes to fraud models or rules for the network.

### RELATED APPLICATIONS

This application claims priority to, and the benefit of, U.S. Provisional Patent Application Ser. No. 62/900,057, filed Sep. 13, 2019, the disclosure of which is hereby incorporated, by reference, in its entirety.

### BACKGROUND OF THE INVENTION

### 1. Field of the Invention

Embodiments are generally directed to systems and methods for using network attributes to identify fraud.

### 2. Description of the Related Art

It is known to link fraud events and cases to the next potential fraud in single hops. For example, a known fraudulent phone number may be used to identify the next potential fraud when the same phone number has been used is a single order hop.

### SUMMARY OF THE INVENTION

Systems and methods for using network attributes to identify fraud are disclosed. In one embodiment, in an information processing apparatus comprising at least one computer processor, a method for using network attributes to identify potential fraud may include: (1) receiving input data comprising at least one of new application data, existing relationship data, customer contact data, and event/transaction data from one or more database, each input data tagged with an indication of fraud or no fraud; (2) transforming the input data into link-level paired data; (3) creating a network mathematically represented by a matrix based on the link-level paired data; (4) creating network attributes from the matrix at an element level, an entity level, and a sub-network level; (5) for each node, link, or sub-network in the network, generating a fraud propensity attribute comprising at least one of a distance, a density, a centrality, and a degree or rate of fraud concentration of based on the network attributes and the input data tagging; and (6) outputting fraud propensity attributes to fraud models or fraud rules from the network

In one embodiment, the node may include an account, an application, or an event.

In one embodiment, the link may include a connection between two nodes.

In one embodiment, the input data may be extracted from one of the new application data, the existing relationship data, the customer contact/interaction data, and the event/transaction data.

In one embodiment, the input data may be transformed into link level paired data by linking common elements in the input data.

In one embodiment, the network attributes may be created using matrix and arithmetic manipulations.

In one embodiment, the method may further include receiving an event; extracting an event attribute from the event; and identifying a potential fraud for the event based on the fraud propensity attributes and the event attribute.

In one embodiment, the event may include an application for a financial account or a transaction involving a financial account.

In one embodiment, the event may include a non-monetary event.

In one embodiment, the method may further include rejecting, flagging, or outsorting the event in response to the event breaching a fraud threshold.

According to another embodiment, a system for using network attributes to identify potential fraud may include a plurality of data sources for input data comprising at least one of new application data, existing relationship data, customer contact data, and event/transaction data, each input data tagged with an indication of fraud or no fraud; a network engine that receives the input data, comprising a link engine that transforms the input data into link-level paired data and creates a network mathematically represented by a matrix based on the link-level paired data and a network attributes engine that creates network attributes from the matrix at an element level, an entity level, and a sub-network level, and generates fraud propensity attributes for each node, link, or sub-network in the network comprising at least one of a distance and a fraud density for each node or link of in the network based on the network attributes and the input data tagging; a plurality of databases for storing the fraud propensity attributes; and a fraud model or a fraud rules engine that receives model scores or fraud rules from the network.

In one embodiment, the node may include an account, an application, or an event.

In one embodiment, the link may include a connection between two nodes.

In one embodiment, the input data may be extracted from one of the new application data, the existing relationship data, the customer contact/interaction data, and the event/transaction data.

In one embodiment, the input data may be transformed into link level paired data by linking common elements in the input data.

In one embodiment, the network attributes may be created using matrix and arithmetic manipulations.

In one embodiment, the fraud model receives an event, extracts an event attribute from the event, and identifies a potential fraud for the event based on the fraud propensity attributes and the event attribute.

In one embodiment, the event may include an application for a financial account or a transaction involving a financial account.

In one embodiment, the event may include a non-monetary event.

In one embodiment, the event may be rejected, flagged, or outsorted in response to the event breaching a fraud threshold.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is an exemplary illustration of identifying single linkages to identify potential fraud;

FIG. 2 depicts an exemplary use case of using social network analysis to identify fraud hopping over multiple links according to an embodiment;

FIG. 3 depicts an exemplary use case of analysis small sample network to identify a fraudulent application according to an embodiment;

FIG. 4 depicts a system for using network attributes to identify fraud according to an embodiment;

FIG. 5 depicts a method for generating one or more network attribute databases for enhancement of fraud detection according to an embodiment; and

FIG. 6 depicts a method for using network attributes to identify transaction fraud according to an embodiment.

### DETAILED DESCRIPTION OF PREFERRED EMBODIMENTS

Embodiments are directed to systems and methods for creating and using network attributes to identify fraud. Examples, include transaction fraud, a fraudulent application for an account, financial instrument, or fraud with a non-monetary event. Consistent with this, while embodiments may be described in the context of a financial institution, it should be recognized that the embodiments are not so limited and have applicability in detecting fraud with other entities.

Embodiments may use social network analysis, network science, and/or graph analytics in a process to assist in building a system of linkages. Social network analysis is the process of investigating social structures through the use of networks or graph theory. It characterizes networked structures in terms of nodes (individual actors, people, or things within the network) and the ties, edges, or links (relationships or interactions) that connect them.

Social network analysis may use the following terms.

Density refers to the “connections” between participants. Density is defined as the number of connections a participant has, divided by the total possible connections a participant could have;

Centrality focuses on the behavior of individual participants within a network. It measures the extent to which an individual interacts with other individuals in the network;

In-degree and out-degree variables are related to centrality. In-degree centrality concentrates on a specific individual as the point of focus; centrality of all other individuals is based on their relation to the focal point of the “in-degree” individual. Out-degree is a measure of centrality that still focuses on a single individual, but the analytic is concerned with the out-going interactions of the individual; the measure of out-degree centrality is how many times the focus point individual interacts with others; and

A sociogram is a visualization with defined boundaries of connections in the network.

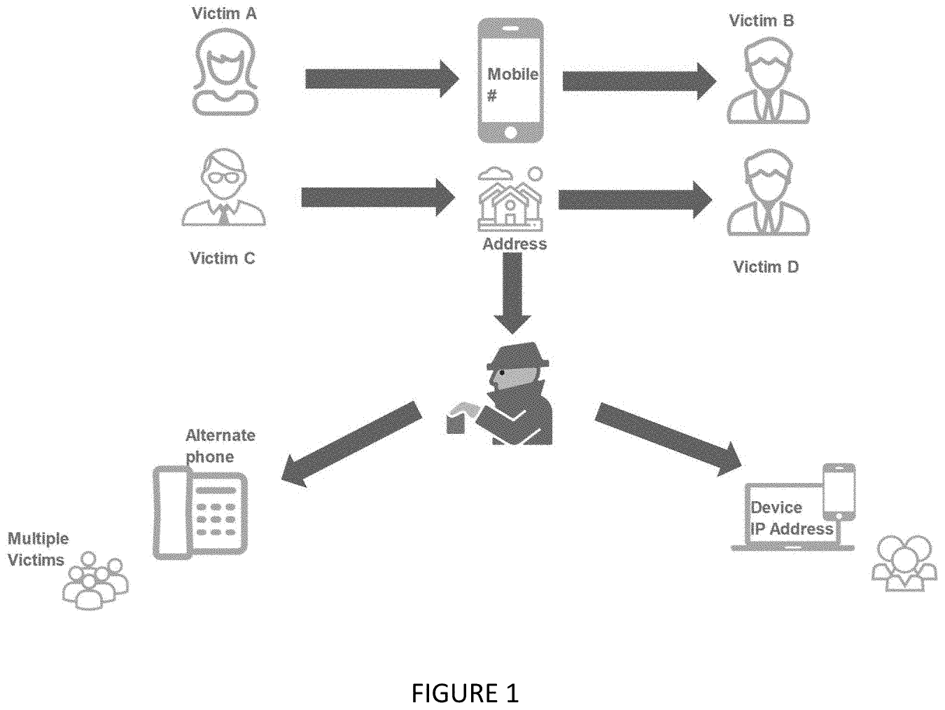

Referring to FIG. 1, a simple example of identifying single linkages, such as a phone number, an email address, etc. to identify potential fraud is provided according to an embodiment.

Victim A and Victim B share, for example, a mobile number.

Victim C and Victim D share, for example, an address. Thus, first order links between known prior fraud phone number or address may identify potential fraud with a new account with the same phone number or address. Similar first order linkages may also tie back to hard coded negative files.

Embodiments may employ one or more network analysis tools to identify higher order linkages, to identify fraud rings where certain credentials are re-used, to use soft-coded negative data that does not age, and to use such derived network intelligence to build fraud rules.

For example, when higher order of linkages are considered, a ring of fraud may be linked to the same modus operandi and common perpetrators that can be quickly identified by taking multiple step jumps through network generation.

In one embodiment, internal data may be supplemented with voice contact data, online contact data, and/or other interaction data between customers and a financial institution that may be used to identify reused identifying elements to spot fraud rings that may specialize in, for example, application fraud or account take over.

Thus, instead of building multiple hops, exhaustive linkages may help identify the full exposure of a trend to an organization, such as a financial institution. By building out the full network, sharper intelligence may be obtained from network attributes, such as the sub-network fraud rate, sub-network reject rate, sub-network density, clustering coefficient, size of the sub network, path length of a node from the closest fraud tagged node, etc., which may be used to sharpen and fire fraud rules to review an account for potential fraud.

In embodiments, the linkages may be identified across all some or all products within an organization. For example, some or all the following elements can be used to perform the links between accounts: (1) phone number; (2) electronic device identifiers; (3) email address; (4) physical address; (5) mother's maiden name, password, etc.; (6) authorized user(s); (7) IP address; (8) demand deposit account (DDA) number to which payment was made; (9) social security number. Any other elements may be used for linkage as is necessary and/or desired.

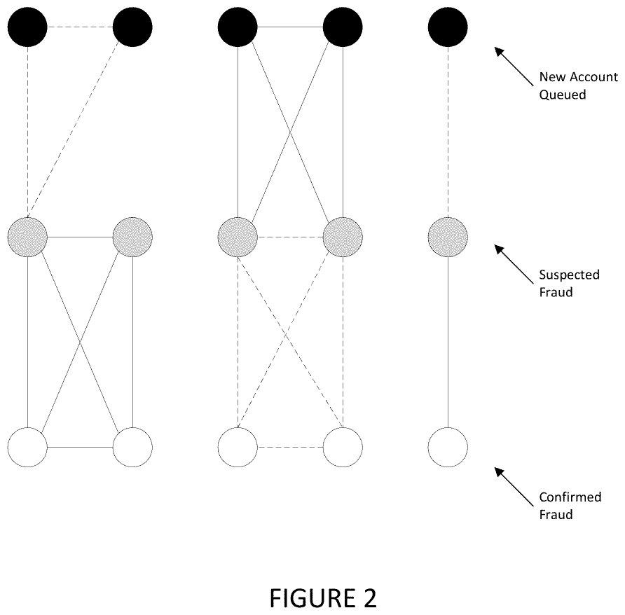

Referring to FIG. 2, an example use case of using social network analysis to identify fraud, such as a fraudulent application for a product, a fraudulent transaction, account take over, etc. is illustrated. Using a single linkage, the first-degree links without confirmed fraud may be suspected based on device, ANI, etc. Thus, the first-degree links are queued as suspected fraud.

Using social network analysis, higher-order linkage may be identified based on exhaustive network searches. Thus, the higher-order links may also be queued. Please note the different types of links in the diagram indicate different elements causing the linkages. The confirmed and suspected fraud may share the same phone, but the suspected fraud and new account queued would have a different common element such that the new account has no common direct linkage to the originally confirmed fraud.

For example, currently, when a new account/application is booked, it is suspected for fraud and queued if it is directly linked to a confirmed fraud. With social network analysis, however, the account may be linked to suspected fraud, where the suspected fraud is itself linked to a confirmed fraud. In other words, a new account may be suspected of fraud using social network analysis and higher order links even when the link to the confirmed known fraud is not direct.

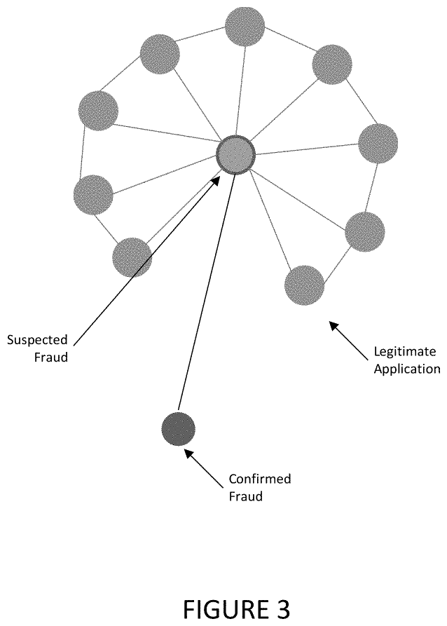

Referring to FIG. 3, an example use case of using social network analysis to identify a fraudulent application is disclosed according to one embodiment. Using a single linkage, the first-degree links may be identified based on, for example, IP address. Using social network analysis, the higher-order links based on phone may not be queued due to low levels of network suspicion. Thus, for example, the suspected fraud node and the confirmed fraud node share an IP address.

In one embodiment, machine learning may be used to drive strong models and highly predictive and very sensitive and quickly changing fraud scores, as the network morphs and changes as nodes are added and/or removed.

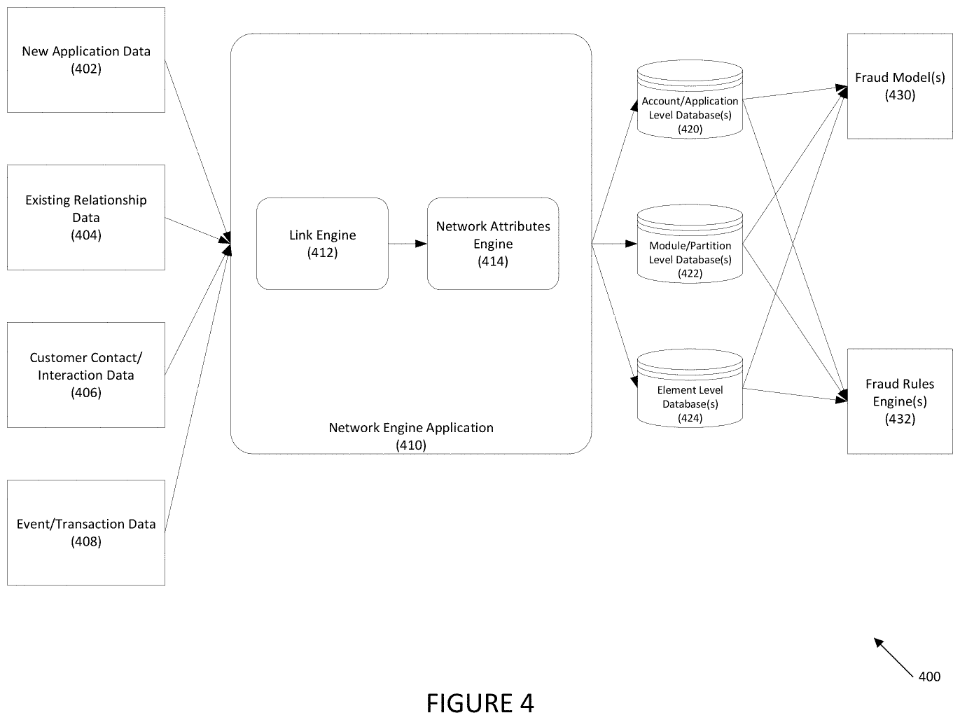

Referring to FIG. 4, an exemplary system for using network attributes to trigger fraud rules for fraud is disclosed. System 400 may include network application engine 410 that may be executed by an electronic device (not shown), such as a server, in the cloud, a computer, an Internet of Things appliance, etc. that may receive, as inputs, new application data 402, existing relationship data 404, customer contact/interaction data 406, and event transaction data 408. Additional and/or other types of data may be received as is necessary and/or desired.

In one embodiment, the data may be received from one or more database, such as databases that may be maintained by a financial institution. In another embodiment, the data may be received from third parties, such as third-party partners, aggregators, social networks, etc. For example, third parties may provide certain information, such as a device id, a voice identification service to identify a voice, etc.

In one embodiment, the data may be received in table form. For example, each row of the table may identify, for example, an individual and associated information (e.g., phone number, address, IP address, device ID, etc.).

New application data 402 may identify data from applications for a good or service that the customer may submit. For example, a customer may submit an application for a credit card, an auto loan, a mortgage, etc. Embodiments may collect and/or extract customer information from the application, such as name, address, phone number, email address, etc., as well as information on the device from which the application was submitted, such as device ID, IP address, password, etc.

Existing relationship data 404 may identify all existing customer relationships with the financial institution. This may include, for example, phone numbers, IP addresses, device IDs, physical addresses, email addresses for all customers having loan account, other bank accounts, credit card accounts, etc. with the financial institution.

Contact/interactions data 406 may include the data on each contact that customers may have with a financial institution, such as the phone number, voiceprint, etc. that may be collected when the customer contact the financial institution, as well as their login-related information (e.g., IP Address, device ID, etc.). This data may be collected at a session/call level and may include online login-based interactions, phone call-based interactions, or interactions on any other available channel (e.g., chat, online submission, etc.).

Event/transaction data 408 may identify transactions completed from a device or IP at the transaction level. The transactions may be monetary (e.g., charges, payments) or non-monetary (e.g., change of address, adding phone number, etc.) in nature. This data may be used to create entity level attributes that are the output of the network calculations.

The data in data sources 402, 404, 406, and 408 may include raw data that may be in a table format of rows and columns. For example, a row in new application data may identify, for example, an application ID, a customer name, a customer phone number, a customer address, etc.

In one embodiment, each input from data sources 402, 404, 406, and 408 may be tagged with a fraud or no fraud indicator based on whether it is known fraud.

Using some or all of these inputs, link engine 412 may convert the data from data sources 402, 404, 406, and 408 into links that link two nodes (e.g., two customers may be linked by the same phone number). Link engine 412 may further generate one or more networks from these links.

Network attribute engine 414 may create network attributes for each network at an application/account level (e.g., node level), at the module level (e.g., sub network level), and at the element level (e.g., edge level). These network attributes describe the same network, but provide different “views.” The network attributes may be enriched with a distance, a density, a centrality, and a degree or rate of fraud concentration to known fraud.

Application/account level data in application level database 422 may include attributes such as the distance of a credit card application from the nearest known fraud in terms of number of hops, the number of links to other applications, the number of frauds amongst the first level linkages, etc. In embodiments, the network attributes may be specific to the account or application. For instance, the distance (e.g., the number of nodes) between the account or application and a known fraud account or application, whether it is linked to fraud or not, the degree of the node or how many other accounts may be linked to this account or application in one step, etc.

Module/partition level data in module/partition level database 422 may include, for example, the module size, the module density, the module fraud rate, the module reject rate, the diameter of the module, etc. that may be good predictors of fraud.

An example of module level data is victims of a particular fraud ring that are reusing the same physical address to receive the card. They may also be reusing the same phone number or password. This would link only the victims of this particular ring to each other.

Element level data in element level database 424 may identify the attributes at the element level. Example of elements include IP addresses, phone numbers, etc. For example, a network attribute at the element level may identify, for example, the number of nodes (e.g., accounts) that a phone number is tied to.

Fraud propensity attributes may be associated with each of these elements. For example, if 50 people are linked to a certain phone number on file, the phone number would have a very high degree, making the accounts associated with the phone number a high fraud risk.

Fraud propensity attributes at the module level may identify the module fraud rate, such as the number of nodes within all the nodes in a sub graph or module that are fraudulent (e.g., a fraud concentration metric).

In one embodiment, network engine 410 output the fraud propensity attributes to one or more database, such as application level database 420, account level database 422, and element level database 424. The fraud propensity attributes in databases 420, 422, 424 may be ingested by downstream systems, such as fraud model(s) 430 and fraud rules engine(s) 432.

For example, fraud propensity attributes (e.g., element level, entity level, and module/subnetwork level) may be output to one or more fraud model 430 to enhance the fraud model's performance. For example, a fraud propensity attributes of a module that an application belongs to, such as fraud density of that module, would significantly increase the probability of fraud if the density of other fraud in the module is very high, and hence make the model performance extremely powerful.

Similarly, fraud propensity attributes (e.g., element level, entity level, module/partition level) may be output to fraud rules engine 432. For example, when strategy teams write rules driving, for instance, which application needs to be outsorted for manual review, or which application should be rejected as fraudulent, these attributes can be leveraged based on, for example, fraud propensity attributes of the entity such as address, phone number, etc. on the application or the fraud propensity attributes associated with the application itself such as the number of hops from a known fraud in the network.

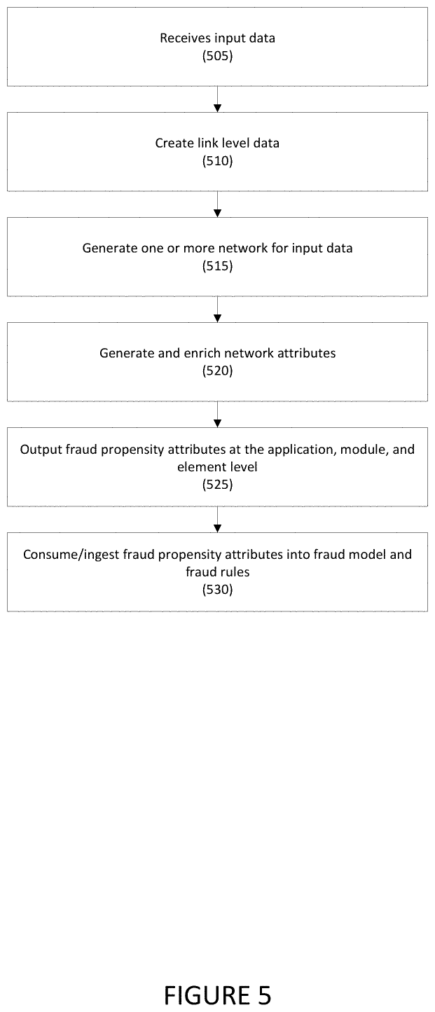

Referring to FIG. 5, a method for generating one or more network attribute databases for enhancement of fraud detection is disclosed according to an embodiment.

In step 505, a computer program or application may receive input data, such as application data, relationship data, contact data, and event/transaction data from one or more database. In one embodiment, the database(s) may be within an organization, provided by third parties, etc.

The input data may be tagged as being fraud or non-fraud. For example, if the application for an application data input is known to be known fraud, that application may be so tagged.

In one embodiment, the data may be pushed to the computer program, may be provided by API, etc.

In step 510, the input data may be transformed into link level paired data that is conducive to creating and representing the network in the form of matrices. For example, if two applications have a common phone number, that would be a first link. All links existing in the incoming data may be identified for each data source, including contact data and transaction data.

In step 515, once the paired link data is identified, the computer program or application may create one or more base networks that are represented in matrix format as an adjacency matrix. Assuming that there are n applications in the database flowing into the computer program or application, the computer program or application then transposes all the records into a matrix. This matrix will compress that into a n by n grid of application to application, where every element in column a and column b contains information on the links between application a and application b. This is called an adjacency network that is used to represent the network.

In 520, the computer program or application may create network attributes using, for example, matrix manipulation, bespoke coding, using network manipulation software, etc. from the matrix. In one embodiment, the computer program or application may generate network attributes at the element level, the application level, and/or the sub-network level. For example, for application data, a database will generally have one record per application with its various attributes such as degree, distance from a known fraud, etc.

The computer program or application may also generate fraud propensity attributes, such as distances, path lengths, modules etc. for each application to known fraud. Some applications are known fraud and others are not, so the matrix and the attributes, such as distances, modules, etc., help identify, for example, the distance of an application to the nearest known fraud. It may also help isolate high fraud rich modules where all other nodes could be potential fraud. It may use weighted links to get the most likely fraudulent application. Social network analysis (SNA), graph theory, etc. may be used to convert data into networks using matrices and getting paths, modules, etc. using matrix algebra.

For example, at the account/application level, the fraud propensity attributes may be specific to the account/application. For instance, the distance to a known fraud account, whether it is linked to fraud or not, the degree of the node or how many other accounts, etc. may be linked to this account in one step.

In step 525, the fraud propensity attributes may be output to databases, such as at the application, module, and element level. This step may be optional, and in embodiments, the network attributes may be ingested directly by one or more downstream system in step 530.

In step 530, one or more downstream system may ingest at least some of the fraud propensity attributes. For example, some fraud propensity attributes may be provided to fraud model(s) that score new incoming applications with the SNA output attributes such as density of the network of the incoming application, the shortest path to fraud, the degree of the phone number on the application etc. This may result in a score that learns with every new application coining in and growing the network, thereby making the score very agile to moving fraud trend as network topology changes. This is in contrast to current fraud models that have static inputs.

In another embodiment, login data may be used to detect fraud. For example, the computer program or application may create a network out of accounts linked by the same device or IP at the time of login, or same linked by voice or phone number at the time of inbound contact. The inputs may trigger similar element level and node level attributes for fraud suspicion.

An example use case is as follows. A known fraud module may be linked to an application by phone number, and the application also linked to 1000 additional applications by device ID. Because the 1000 applications are not directly linked to the known fraud, a negative file process would not catch the fraud. This whole module has a relatively large size of 1002 (including current application and the known fraud application). So, because the number of applications associated with the module is over a threshold (e.g., 1000), a fraud rule may be triggered based on high module size. This would stop fraud on 1000 potential fraud applications.

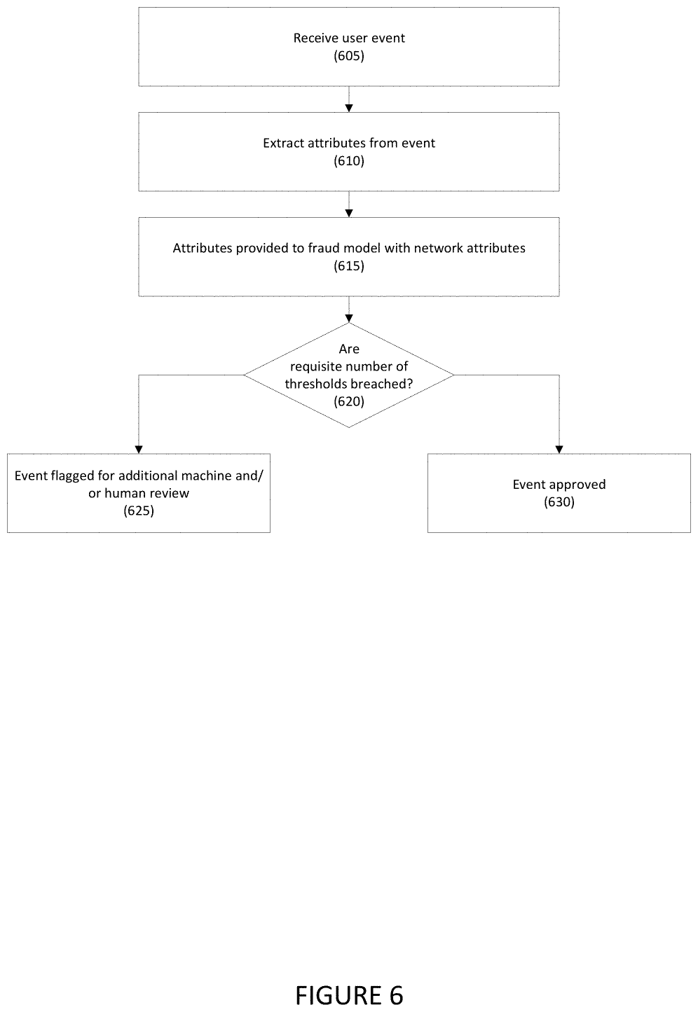

Referring to FIG. 6, a method for identification of fraud using network attributes is provided according to an embodiment.

In step 605, an event may be received. For example, the event may be a new application submission (e.g., an application for a financial account, credit card, loan, etc.), a financial transaction (e.g., a credit card transaction, a money transfer, etc.), or a non-monetary transaction (e.g., change account login credentials, change password, etc.).

In step 610, event attributes from the event may be extracted. For example, the user's name, phone number, address, device identifier, IP address, etc. may be extracted as available.

In step 615, the event attributes may be provided as inputs to one of more fraud model that has ingested fraud propensity attributes as discussed above. In one embodiment, the fraud model has set certain threshold for different attributes, such as a number of steps from a known fraud node (e.g., less than 3 steps from known fraud), a number of shared links with an element (e.g., greater than 5 shared links), and a minimum sub graph fraud rate (e.g., greater than 15%). These thresholds are exemplary only, and it should be recognized that different thresholds and/or different network attributes may be considered as is necessary and/or desired.

In one embodiment, machine learning may be used to select the network attributes and/or the thresholds.

In step 620, fraud may be suspected if one or more threshold is breached. For example, if the node is within 3 steps from known fraud, fraud may be suspected. If the node shares links with 5 or more nodes, fraud may be suspected. If the sub-graph has a fraud rate of greater than 15%, fraud may be suspected. Again, these network attributes and thresholds are illustrative only.

In one embodiment, more than one threshold may be required to be breached to suspect fraud.

In step 620, if the requisite number of threshold are breached, in step 625, the event (e.g., new application submission, transaction, etc.) may be flagged for additional machine and/or manual review, may be rejected, etc.

In step 620, if the requisite number of threshold are not breached, in step 630, the event may be approved.

Although several embodiments have been disclosed, it should be recognized that these embodiments are not exclusive to each other, and certain elements or features from one embodiment may be used with another.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, JavaScript, R, Phyton, SCALA, etc. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for using network attributes to identify potential fraud, comprising:
in an information processing apparatus comprising at least one computer processor:
receiving input data comprising at least one of new application data, existing relationship data, customer contact data, and event/transaction data from one or more database, each input data tagged with an indication of fraud or no fraud;
transforming the input data into link-level paired data;
creating a network mathematically represented by a matrix based on the link-level paired data;
creating network attributes from the matrix at an element level, an entity level, and a sub-network level;
for each node, link, or sub-network in the network, generating a fraud propensity attribute comprising at least one of a distance, a density, a centrality, and a degree or rate of fraud concentration of based on the network attributes and the input data tagging; and
outputting fraud propensity attributes to fraud models or fraud rules from the network.

2. The method of claim 1, wherein the node comprises an account, an application, or an event.

3. The method of claim 1, wherein the link comprises a connection between two nodes.

4. The method of claim 1, wherein the input data is extracted from one of the new application data, the existing relationship data, the customer contact/interaction data, and the event/transaction data.

5. The method of claim 1, wherein the input data is transformed into link level paired data by linking common elements in the input data.

6. The method of claim 1, wherein the network attributes are created using matrix and arithmetic manipulations.

7. The method of claim 1, further comprising:
receiving an event;
extracting an event attribute from the event; and
identifying a potential fraud for the event based on the fraud propensity attributes and the event attribute.

8. The method of claim 7, wherein the event comprises an application for a financial account or a transaction involving a financial account.

9. The method of claim 7, wherein the event comprises a non-monetary event.

10. The method of claim 7, further comprising:
rejecting, flagging, or outsorting the event in response to the event breaching a fraud threshold.

11. A system for using network attributes to identify potential fraud, comprising:
a plurality of data sources for input data comprising at least one of new application data, existing relationship data, customer contact data, and event/transaction data, each input data tagged with an indication of fraud or no fraud;
a network engine that receives the input data, comprising:
a link engine that transforms the input data into link-level paired data and creates a network mathematically represented by a matrix based on the link-level paired data; and
a network attributes engine that creates network attributes from the matrix at an element level, an entity level, and a sub-network level, and generates fraud propensity attributes for each node, link, or sub-network in the network comprising at least one of a distance and a fraud density for each node or link of in the network based on the network attributes and the input data tagging;
a plurality of databases for storing the fraud propensity attributes; and
a fraud model or a fraud rules engine that receives model scores or fraud rules from the network.

12. The system of claim 11, wherein the node comprises an account, an application, or an event.

13. The system of claim 11, wherein the link comprises a connection between two nodes.

14. The system of claim 11, wherein the input data is extracted from one of the new application data, the existing relationship data, the customer contact/interaction data, and the event/transaction data.

15. The system of claim 11, wherein the input data is transformed into link level paired data by linking common elements in the input data.

16. The system of claim 11, wherein the network attributes are created using matrix and arithmetic manipulations.

17. The system of claim 11, wherein the fraud model receives an event, extracts an event attribute from the event, and identifies a potential fraud for the event based on the fraud propensity attributes and the event attribute.

18. The system of claim 17, wherein the event comprises an application for a financial account or a transaction involving a financial account.

19. The system of claim 17, where event comprises a non-monetary event.

20. The system of claim 17, wherein the event is rejected, flagged, or outsorted in response to the event breaching a fraud threshold.
